(19) United States
(12) Patent Application Publication
(10) Pub. No.: US 2008/0299921 A1
(43) Pub. Date: Dec. 4, 2008

(54) ON-CHIP DIRECTIONAL COUPLER FOR RF TRANSMITTER OUTPUT POWER MEASUREMENT

(75) Inventor: Hsin-Hsing Liao, San Diego, CA (US)

Correspondence Address: GARLICK HARRISON & MARKISON, P.O. BOX 160727, AUSTIN, TX, 78716-0727, US

(73) Assignee: BROADCOM CORPORATION, Irvine, CA (US)

(21) Appl. No.: 11/768,745

(22) Filed: Jun. 26, 2007

Related U.S. Application Data
(60) Provisional application No. 60/941,515, filed on Jun. 1, 2007.

(51) Int. Cl. H04B 17/02

(52) U.S. Cl. 455/115.3

(57) ABSTRACT

An integrated circuit radio transceiver and method therefor include circuitry for generating and power amplifying an outgoing RF signal to produce a power amplified outgoing signal, conducting the power amplified outgoing signal down a transmission path that is disposed substantially parallel to a directional coupler formed on a metallization layer of the integrated circuit, producing a sensed signal level sensed in the directional coupler to a power detector and determining the forward output power based upon the sensed signal level.

### CROSS REFERENCE TO RELATED PATENTS

This U.S. application for patent claims the benefit of the filing date of U.S. Provisional Patent Application having Ser. No. 60/941,515, filed on Jun. 1, 2007, which is incorporated herein by reference for all purposes.

### SPECIFICATION

### BACKGROUND

1. Technical Field

The present invention relates to wireless communications and, more particularly, to circuitry for wireless communications.

2. Related Art

Communication systems are known to support wireless and wire lined communications between wireless and/or wire lined communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards, including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

Depending on the type of wireless communication system, a wireless communication device, such as a cellular telephone, two-way radio, personal digital assistant (PDA), personal computer (PC), laptop computer, home entertainment equipment, etc., communicates directly or indirectly with other wireless communication devices. For direct communications (also known as point-to-point communications), the participating wireless communication devices tune their receivers and transmitters to the same channel or channels (e.g., one of a plurality of radio frequency (RF) carriers of the wireless communication system) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via a public switch telephone network (PSTN), via the Internet, and/or via some other wide area network.

Each wireless communication device includes a built-in radio transceiver (i.e., receiver and transmitter) or is coupled to an associated radio transceiver (e.g., a station for in-home and/or in-building wireless communication networks, RF modem, etc.). As is known, the transmitter includes a data modulation stage, one or more intermediate frequency stages, and a power amplifier stage. The data modulation stage converts raw data into baseband signals in accordance with the particular wireless communication standard. The one or more intermediate frequency stages mix the baseband signals with one or more local oscillations to produce RF signals. The power amplifier stage amplifies the RF signals prior to transmission via an antenna.

Typically, the data modulation stage is implemented on a baseband processor chip, while the intermediate frequency (IF) stages and power amplifier stage are implemented on a separate radio processor chip. Historically, radio integrated circuits have been designed using bi-polar circuitry, allowing for large signal swings and linear transmitter component behavior. Therefore, many legacy baseband processors employ analog interfaces that communicate analog signals to and from the radio processor.

Designs for wireless transceivers are continuously evolving to improve performance. Desired performance improvements include improvements in signal quality, power consumption (efficiency), and size and weight reductions. As such, there is a continuing need for inventions to the design and implementation of wireless transceivers that improve at least one of the signal quality, power consumption, weight or size of the device.

### SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

A better understanding of the present invention can be obtained when the following detailed description of the preferred embodiment is considered with the following drawings, in which:

FIG. 1 is a schematic block diagram illustrating a wireless communication device that includes a host device and an associated radio;

FIG. 2 is a schematic block diagram illustrating a wireless communication host device and an associated radio;

FIG. 3 is a schematic block diagram illustrating a wireless communication host device and an associated radio having multiple transmit and receive paths according to one embodiment of the invention;

FIG. 4 is a functional block diagram of an integrated circuit radio transceiver comprising a directional coupler according to one embodiment of the invention;

FIG. 5 is a functional block diagram that illustrates the power detection module according to one embodiment of the invention in greater detail;

FIG. 6 is a functional block diagram that illustrates an alternate embodiment for on-chip directional couplers;

FIGS. 7 and 8 are a functional block diagram illustrating alternate embodiments of the present invention; and

FIG. 9 is a flow chart that illustrates a method in an integrated circuit for detecting forward output power being produced by a power amplifier on a transmit path of the integrated circuit.

### DETAILED DESCRIPTION OF THE DRAWINGS

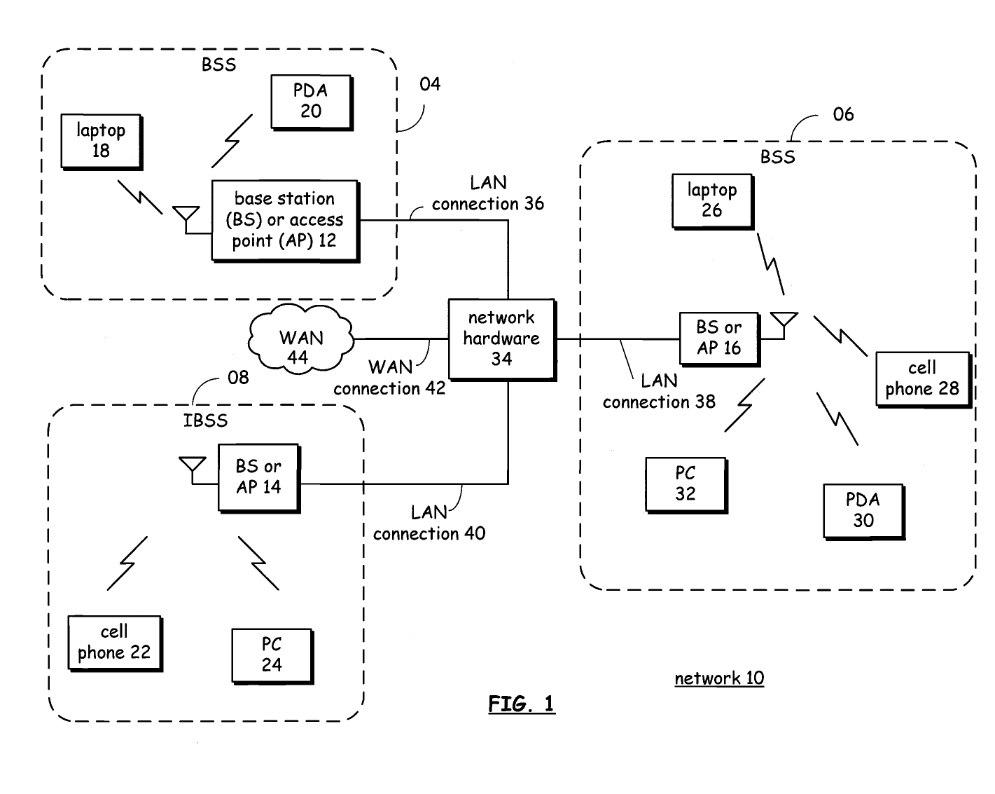

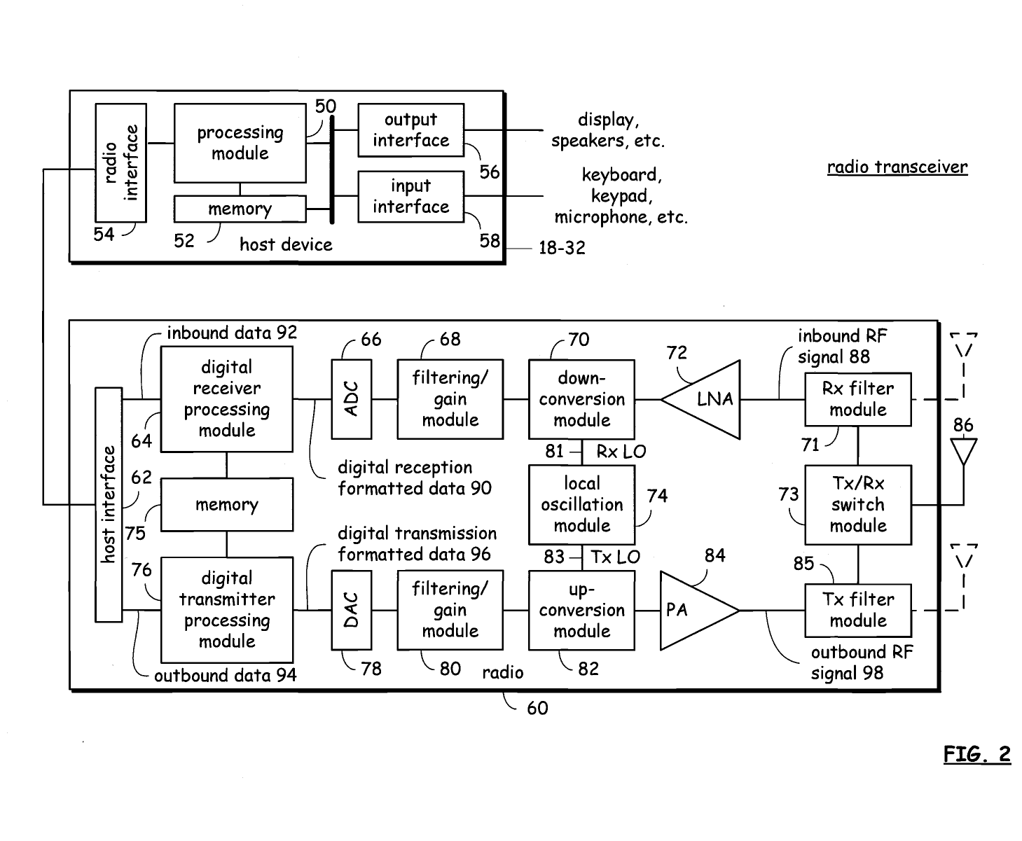

FIG. 1 is a functional block diagram illustrating a communication system that includes circuit devices and network elements and operation thereof according to one embodiment of the invention. More specifically, a plurality of network service areas 04, 06 and 08 are a part of a network 10. Network 10 includes a plurality of base stations or access points (APs) 12-16, a plurality of wireless communication devices 18-32 and a network hardware component 34. The wireless communication devices 18-32 may be laptop computers 18 and 26, personal digital assistants 20 and 30, personal computers 24 and 32 and/or cellular telephones 22 and 28. The details of the wireless communication devices will be described in greater detail with reference to FIGS. 2-10.

The base stations or APs 12-16 are operably coupled to the network hardware component 34 via local area network (LAN) connections 36, 38 and 40. The network hardware component 34, which may be a router, switch, bridge, modem, system controller, etc., provides a wide area network (WAN) connection 42 for the communication system 10 to an external network element such as WAN 44. Each of the base stations or access points 12-16 has an associated antenna or antenna array to communicate with the wireless communication devices in its area. Typically, the wireless communication devices 18-32 register with the particular base station or access points 12-16 to receive services from the communication system 10. For direct connections (i.e., point-to-point communications), wireless communication devices communicate directly via an allocated channel.

Typically, base stations are used for cellular telephone systems and like-type systems, while access points are used for in-home or in-building wireless networks. Regardless of the particular type of communication system, each wireless communication device includes a built-in radio and/or is coupled to a radio.

FIG. 2 is a schematic block diagram illustrating a wireless communication host device 18-32 and an associated radio 60. For cellular telephone hosts, radio 60 is a built-in component. For personal digital assistants hosts, laptop hosts, and/or personal computer hosts, the radio 60 may be built-in or an externally coupled component.

As illustrated, wireless communication host device 18-32 includes a processing module 50, a memory 52, a radio interface 54, an input interface 58 and an output interface 56. Processing module 50 and memory 52 execute the corresponding instructions that are typically done by the host device. For example, for a cellular telephone host device, processing module 50 performs the corresponding communication functions in accordance with a particular cellular telephone standard.

Radio interface 54 allows data to be received from and sent to radio 60. For data received from radio 60 (e.g., inbound data), radio interface 54 provides the data to processing module 50 for further processing and/or routing to output interface 56. Output interface 56 provides connectivity to an output device such as a display, monitor, speakers, etc., such that the received data may be displayed. Radio interface 54 also provides data from processing module 50 to radio 60. Processing module 50 may receive the outbound data from an input device such as a keyboard, keypad, microphone, etc., via input interface 58 or generate the data itself. For data received via input interface 58, processing module 50 may perform a corresponding host function on the data and/or route it to radio 60 via radio interface 54.

Radio 60 includes a host interface 62, a digital receiver processing module 64, an analog-to-digital converter 66, a filtering/gain module 68, a down-conversion module 70, a low noise amplifier 72, a receiver filter module 71, a transmitter/receiver (Tx/Rx) switch module 73, a local oscillation module 74, a memory 75, a digital transmitter processing module 76, a digital-to-analog converter 78, a filtering/gain module 80, an up-conversion module 82, a power amplifier 84, a transmitter filter module 85, and an antenna 86 operatively coupled as shown. The antenna 86 is shared by the transmit and receive paths as regulated by the Tx/Rx switch module 73. The antenna implementation will depend on the particular standard to which the wireless communication device is compliant.

Digital receiver processing module 64 and digital transmitter processing module 76, in combination with operational instructions stored in memory 75, execute digital receiver functions and digital transmitter functions, respectively. The digital receiver functions include, but are not limited to, demodulation, constellation demapping, decoding, and/or descrambling. The digital transmitter functions include, but are not limited to, scrambling, encoding, constellation mapping, and modulation. Digital receiver and transmitter processing modules 64 and 76, respectively, may be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions.

Memory 75 may be a single memory device or a plurality of memory devices. Such a memory device may be a read-only memory, random access memory, volatile memory, non-volatile memory, static memory, dynamic memory, flash memory, and/or any device that stores digital information. Note that when digital receiver processing module 64 and/or digital transmitter processing module 76 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. Memory 75 stores, and digital receiver processing module 64 and/or digital transmitter processing module 76 executes, operational instructions corresponding to at least some of the functions illustrated herein.

In operation, radio 60 receives outbound data 94 from wireless communication host device 18-32 via host interface 62. Host interface 62 routes outbound data 94 to digital transmitter processing module 76, which processes outbound data 94 in accordance with a particular wireless communication standard or protocol (e.g., IEEE 802.11(a), IEEE 802.11b, Bluetooth, etc.) to produce digital transmission formatted data 96. Digital transmission formatted data 96 will be a digital baseband signal or a digital low IF signal, where the low IF typically will be in the frequency range of one hundred kilohertz to a few megahertz.

Digital-to-analog converter 78 converts digital transmission formatted data 96 from the digital domain to the analog domain. Filtering/gain module 80 filters and/or adjusts the gain of the analog baseband signal prior to providing it to up-conversion module 82. Up-conversion module 82 directly converts the analog baseband signal, or low IF signal, into an RF signal based on a transmitter local oscillation 83 provided by local oscillation module 74. Power amplifier 84 amplifies the RF signal to produce an outbound RF signal 98, which is filtered by transmitter filter module 85. The antenna 86 transmits outbound RF signal 98 to a targeted device such as a base station, an access point and/or another wireless communication device.

Radio 60 also receives an inbound RF signal 88 via antenna 86, which was transmitted by a base station, an access point, or another wireless communication device. The antenna 86 provides inbound RF signal 88 to receiver filter module 71 via Tx/Rx switch module 73, where Rx filter module 71 bandpass filters inbound RF signal 88. The Rx filter module 71 provides the filtered RF signal to low noise amplifier 72, which amplifies inbound RF signal 88 to produce an amplified inbound RF signal. Low noise amplifier 72 provides the amplified inbound RF signal to down-conversion module 70, which directly converts the amplified inbound RF signal into an inbound low IF signal or baseband signal based on a receiver local oscillation 81 provided by local oscillation module 74. Down-conversion module 70 provides the inbound low IF signal or baseband signal to filtering/gain module 68. Filtering/gain module 68 may be implemented in accordance with the teachings of the present invention to filter and/or attenuate the inbound low IF signal or the inbound baseband signal to produce a filtered inbound signal.

Analog-to-digital converter 66 converts the filtered inbound signal from the analog domain to the digital domain to produce digital reception formatted data 90. Digital receiver processing module 64 decodes, descrambles, demaps, and/or demodulates digital reception formatted data 90 to recapture inbound data 92 in accordance with the particular wireless communication standard being implemented by radio 60. Host interface 62 provides the recaptured inbound data 92 to the wireless communication host device 18-32 via radio interface 54.

As one of average skill in the art will appreciate, the wireless communication device of FIG. 2 may be implemented using one or more integrated circuits. For example, the host device may be implemented on a first integrated circuit, while digital receiver processing module 64, digital transmitter processing module 76 and memory 75 may be implemented on a second integrated circuit, and the remaining components of radio 60, less antenna 86, may be implemented on a third integrated circuit. As an alternate example, radio 60 may be implemented on a single integrated circuit. As yet another example, processing module 50 of the host device and digital receiver processing module 64 and digital transmitter processing module 76 may be a common processing device implemented on a single integrated circuit.

Memory 52 and memory 75 may be implemented on a single integrated circuit and/or on the same integrated circuit as the common processing modules of processing module 50, digital receiver processing module 64, and digital transmitter processing module 76. As will be described, it is important that accurate oscillation signals are provided to mixers and conversion modules. A source of oscillation error is noise coupled into oscillation circuitry through integrated circuitry biasing circuitry. One embodiment of the present invention reduces the noise by providing a selectable pole low pass filter in current mirror devices formed within the one or more integrated circuits.

Local oscillation module 74 includes circuitry for adjusting an output frequency of a local oscillation signal provided therefrom. Local oscillation module 74 receives a frequency correction input that it uses to adjust an output local oscillation signal to produce a frequency corrected local oscillation signal output. While local oscillation module 74, up-conversion module 82 and down-conversion module 70 are implemented to perform direct conversion between baseband and RF, it is understood that the principles herein may also be applied readily to systems that implement an intermediate frequency conversion step at a low intermediate frequency.

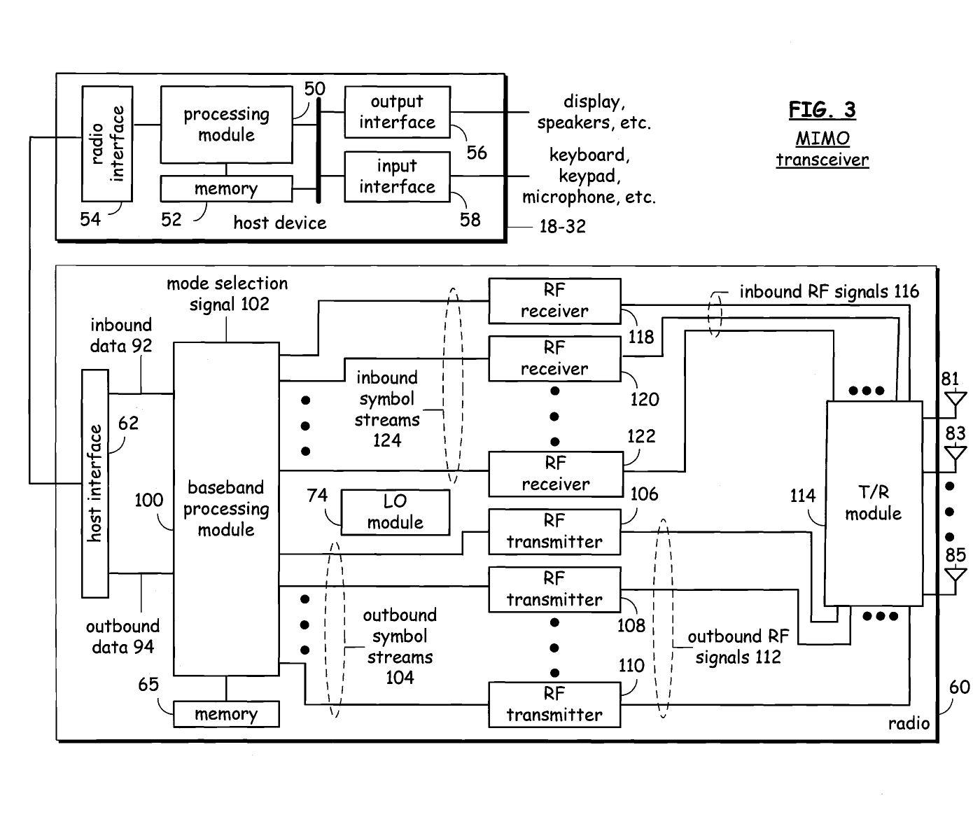

FIG. 3 is a schematic block diagram illustrating a wireless communication device that includes the host device 18-32 and an associated radio 60. For cellular telephone hosts, the radio 60 is a built-in component. For personal digital assistants hosts, laptop hosts, and/or personal computer hosts, the radio 60 may be built-in or an externally coupled component.

As illustrated, the host device 18-32 includes a processing module 50, memory 52, radio interface 54, input interface 58 and output interface 56. The processing module 50 and memory 52 execute the corresponding instructions that are typically done by the host device. For example, for a cellular telephone host device, the processing module 50 performs the corresponding communication functions in accordance with a particular cellular telephone standard.

The radio interface 54 allows data to be received from and sent to the radio 60. For data received from the radio 60 (e.g., inbound data), the radio interface 54 provides the data to the processing module 50 for further processing and/or routing to the output interface 56. The output interface 56 provides connectivity to an output display device such as a display, monitor, speakers, etc., such that the received data may be displayed. The radio interface 54 also provides data from the processing module 50 to the radio 60. The processing module 50 may receive the outbound data from an input device such as a keyboard, keypad, microphone, etc., via the input interface 58 or generate the data itself. For data received via the input interface 58, the processing module 50 may perform a corresponding host function on the data and/or route it to the radio 60 via the radio interface 54.

Radio 60 includes a host interface 62, a baseband processing module 100, memory 65, a plurality of radio frequency (RF) transmitters 106-110, a transmit/receive (T/R) module 114, a plurality of antennas 81-85, a plurality of RF receivers 118-120, and a local oscillation module 74. The baseband processing module 100, in combination with operational instructions stored in memory 65, executes digital receiver functions and digital transmitter functions, respectively. The digital receiver functions include, but are not limited to, digital intermediate frequency to baseband conversion, demodulation, constellation demapping, decoding, de-interleaving, fast Fourier transform, cyclic prefix removal, space and time decoding, and/or descrambling. The digital transmitter functions include, but are not limited to, scrambling, encoding, interleaving, constellation mapping, modulation, inverse fast Fourier transform, cyclic prefix addition, space and time encoding, and digital baseband to IF conversion. The baseband processing module 100 may be implemented using one or more processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 65 may be a single memory device or a plurality of memory devices. Such a memory device may be a read-only memory, random access memory, volatile memory, non-volatile memory, static memory, dynamic memory, flash memory, and/or any device that stores digital information. Note that when the baseband processing module 100 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

In operation, the radio 60 receives outbound data 94 from the host device via the host interface 62. The baseband processing module 100 receives the outbound data 94 and, based on a mode selection signal 102, produces one or more outbound symbol streams 104. The mode selection signal 102 will indicate a particular mode of operation that is compliant with one or more specific modes of the various IEEE 802.11 standards. For example, the mode selection signal 102 may indicate a frequency band of 2.4 GHz, a channel bandwidth of 20 or 22 MHz and a maximum bit rate of 54 megabits-per-second. In this general category, the mode selection signal will further indicate a particular rate ranging from 1 megabit-per-second to 54 megabits-per-second. In addition, the mode selection signal will indicate a particular type of modulation, which includes, but is not limited to, Barker Code Modulation, BPSK, QPSK, CCK, 16 QAM and/or 64 QAM. The mode selection signal 102 may also include a code rate, a number of coded bits per subcarrier (NBPSC), coded bits per OFDM symbol (NCBPS), and/or data bits per OFDM symbol (NDBPS). The mode selection signal 102 may also indicate a particular channelization for the corresponding mode that provides a channel number and corresponding center frequency. The mode selection signal 102 may further indicate a power spectral density mask value and a number of antennas to be initially used for a MIMO communication.

The baseband processing module 100, based on the mode selection signal 102 produces one or more outbound symbol streams 104 from the outbound data 94. For example, if the mode selection signal 102 indicates that a single transmit antenna is being utilized for the particular mode that has been selected, the baseband processing module 100 will produce a single outbound symbol stream 104. Alternatively, if the mode selection signal 102 indicates 2, 3 or 4 antennas, the baseband processing module 100 will produce 2, 3 or 4 outbound symbol streams 104 from the outbound data 94.

Depending on the number of outbound symbol streams 104 produced by the baseband processing module 100, a corresponding number of the RF transmitters 106-110 will be enabled to convert the outbound symbol streams 104 into outbound RF signals 112. In general, each of the RF transmitters 106-110 includes a digital filter and upsampling module, a digital-to-analog conversion module, an analog filter module, a frequency up conversion module, a power amplifier, and a radio frequency bandpass filter. The RF transmitters 106-110 provide the outbound RF signals 112 to the transmit/receive module 114, which provides each outbound RF signal to a corresponding antenna 81-85.

When the radio 60 is in the receive mode, the transmit/receive module 114 receives one or more inbound RF signals 116 via the antennas 81-85 and provides them to one or more RF receivers 118-122. The RF receiver 118-122 converts the inbound RF signals 116 into a corresponding number of inbound symbol streams 124. The number of inbound symbol streams 124 will correspond to the particular mode in which the data was received. The baseband processing module 100 converts the inbound symbol streams 124 into inbound data 92, which is provided to the host device 18-32 via the host interface 62.

As one of average skill in the art will appreciate, the wireless communication device of FIG. 3 may be implemented using one or more integrated circuits. For example, the host device may be implemented on a first integrated circuit, the baseband processing module 100 and memory 65 may be implemented on a second integrated circuit, and the remaining components of the radio 60, less the antennas 81-85, may be implemented on a third integrated circuit. As an alternate example, the radio 60 may be implemented on a single integrated circuit. As yet another example, the processing module 50 of the host device and the baseband processing module 100 may be a common processing device implemented on a single integrated circuit. Further, the memory 52 and memory 65 may be implemented on a single integrated circuit and/or on the same integrated circuit as the common processing modules of processing module 50 and the baseband processing module 100.

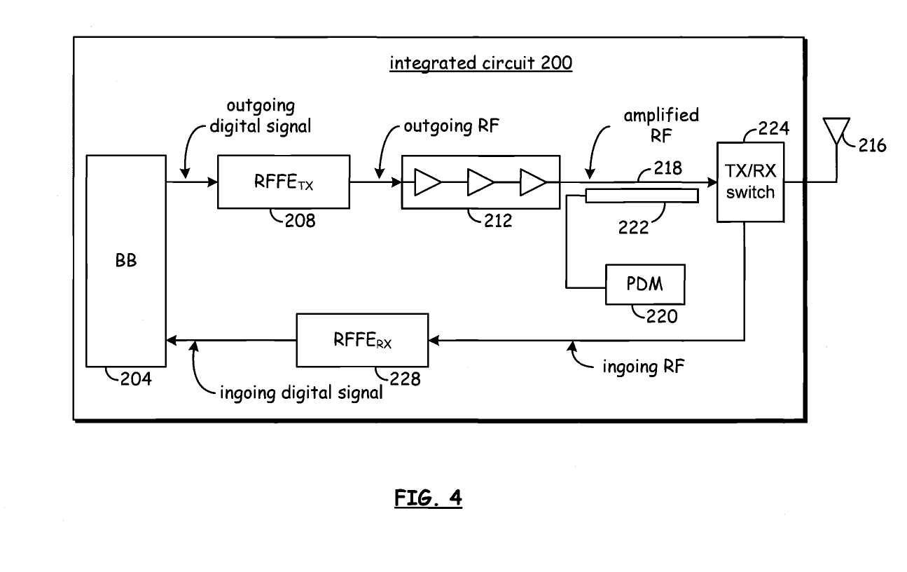

FIG. 4 is a functional block diagram of an integrated circuit radio transceiver comprising a directional coupler according to one embodiment of the invention. As may be seen, integrated circuit 200 includes a baseband processor 204 that produces outgoing digital signals to transmit radio frequency front end 208 which is operable to generate outgoing radio frequency signals (RF) based upon the outgoing digital signals. The outgoing RF is then produced to power amplifier 212 that produces an amplified RF to antenna 216 over outgoing transmission line 218 for over air transmission by way of a transmit/receive switch 224. A power detection module (PDM) 220 is formed on-chip to detect forward output power on an outgoing transmission line 218. As may be seen, a forward power direct coupler 222 is operably disposed in a substantially parallel manner to line 218. A receiving end (coupled end) of coupler 222 is connected to PDM 220.

Further, ingoing RF received at antenna 216 is produced to receive front end 228 (by way of switch 224) that is operable to produce an ingoing digital signal to baseband processor 204 for processing based upon the ingoing RF. It should be understood that other known radio elements are not shown here but may be included. For example, low noise amplification circuitry to amplify the ingoing RF may be part of receive front end 224 or may be operably disposed between antenna 216 and receive front end 224.

In operation, power amplifier 212 produces amplified RF which is conducted on outgoing transmission line 218 and is detected by on-chip directional coupler 222 for sensing the forward output power level and an associated power detection circuit shown as PDM 220 that is operably coupled to the on-chip directional coupler 222 to produce the detected forward output power based upon the sensed forward output power.

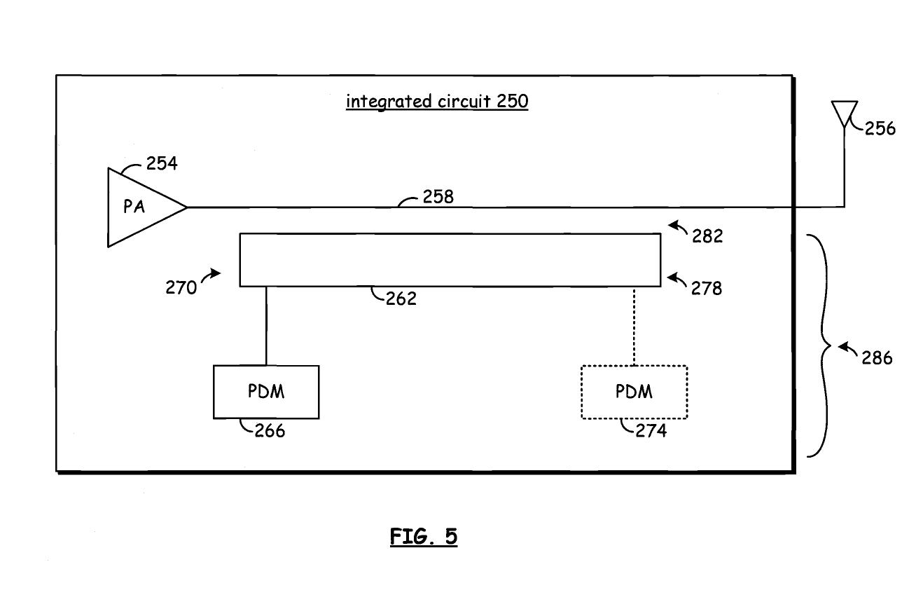

FIG. 5 is a functional block diagram that illustrates the power detection module according to one embodiment of the invention in greater detail. Integrated circuit 250 includes a power amplifier 254 that is operably coupled to antenna 256 by way of an outgoing transmission line 258. A strip line 262 is operably disposed in a substantially parallel manner to outgoing transmission line 258. A power detection circuit 266 is operably disposed to a front (receiving) end 270 of strip line 262 to produce a detected forward output power level based upon forward output power level sensed by strip line 262. In traditional coupler terminology, front end 270 may be referred to as the coupled port.

An additional power detect circuit 274 may be operably disposed to a back end 278 of strip line 262 to sense reflected power for power detection measurements and calculations. Including power detect circuit 274 at the isolated port of the directional coupler (back end 278) is optional. As may further be seen, a separation distance 282 between strip line 262 and transmission line 258 is shown. Typically, separation distance 282 is desirably a minimal value to improve sensing of the forward output power. In one embodiment, the separation distance is in the range of 2-5 microns. As technological advances allow for this separation distance to be reduced, embodiments of the invention will include even lower separation distances (e.g. approximately one micron).

In the described embodiments, the directional coupler is a ¼ wavelength directional coupler operable to detect forward output power levels at a frequency that is approximately a whole multiple of the RF transmission frequency. Alternatively, the directional coupler further may comprises two ⅛ wavelength directional couplers operable to detect forward output power levels at a frequency that is approximately a whole multiple of the RF transmission frequency.

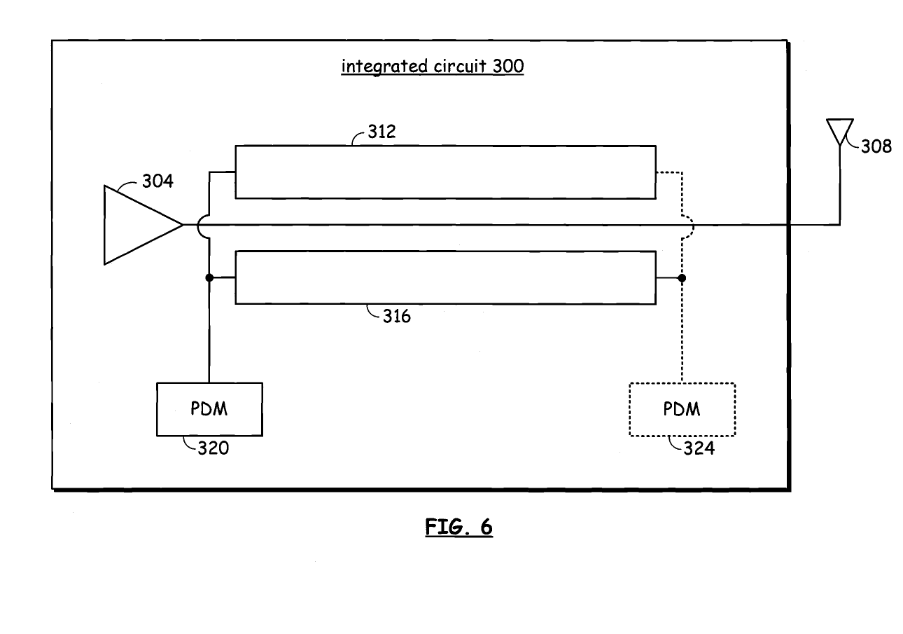

FIG. 6 is a functional block diagram that illustrates an alternate embodiment for on-chip directional couplers. In the embodiment of FIG. 6, an integrated circuit 300 includes a power amplifier 304 that produces amplified RF for broadcast transmission from antenna 308. Two ⅛ wavelength couplers 312 and 316 are electrically coupled to operate as a single ¼ wavelength coupler to produce sensed power to power detect module 320. In general, each of the directional couplers 312 and 316 is disposed substantially parallel to an outgoing transmission line that couples the power amplifier to the antenna.

Under current technological limitations, the couplers are disposed substantially parallel to an outgoing transmission line that couples the power amplifier to the antenna with a minimal separation distance from the outgoing transmission line that is in the range of 2-5 microns. As may further be seen, an optional power detect module 324 may be included at the isolated ports of couplers 312 and 316 to detect reflected power for use in forward output and other power determinations.

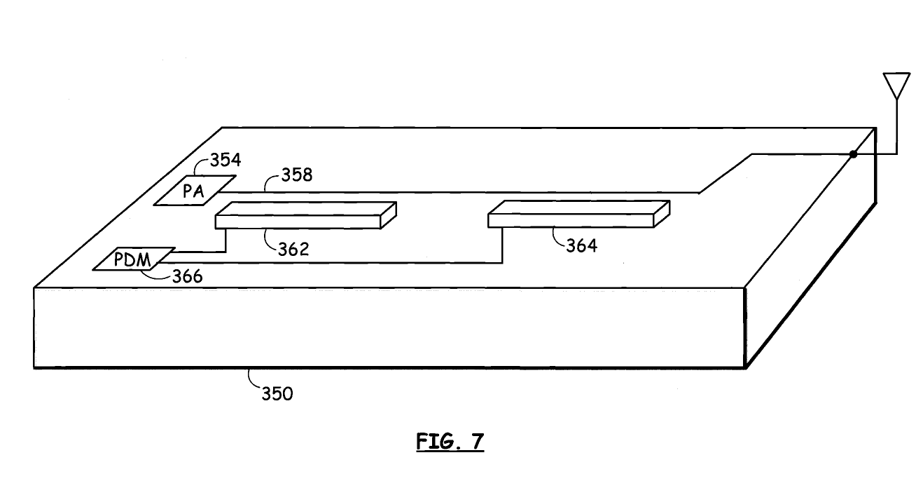

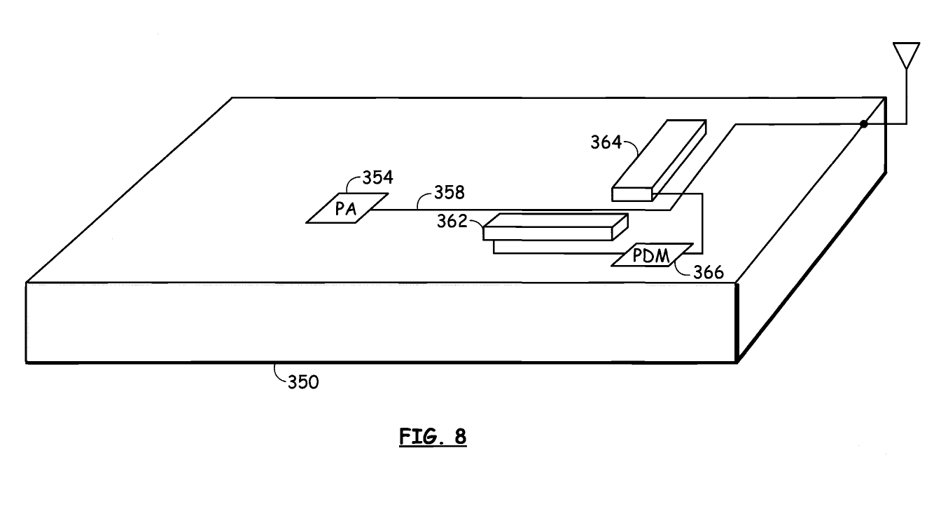

FIGS. 7 and 8 are a functional block diagram illustrating alternate embodiments of the present invention. Here, integrated circuit 350 includes power amplifier 350 that produces an amplified RF for transmission on transmission line 358. Two ⅛ wavelength couplers 362 and 364 are electrically coupled to operate as a single ¼ wavelength coupler to produce sensed power to power detect module 366. In the described embodiment of the invention, the directional couplers comprise strip lines formed on a metallization layer of the integrated circuit 350. Further, as may be seen, strip lines 362 and 364 are disposed on the same side as each other in relation to transmission line 358. FIG. 8 shows an alternate arrangement of the strip line couplers in relation to the transmission line. Here, couplers 362 and 364 are disposed to sense forward output power on different portions of transmission line 358 and are arranged on different sides of transmission line 358.

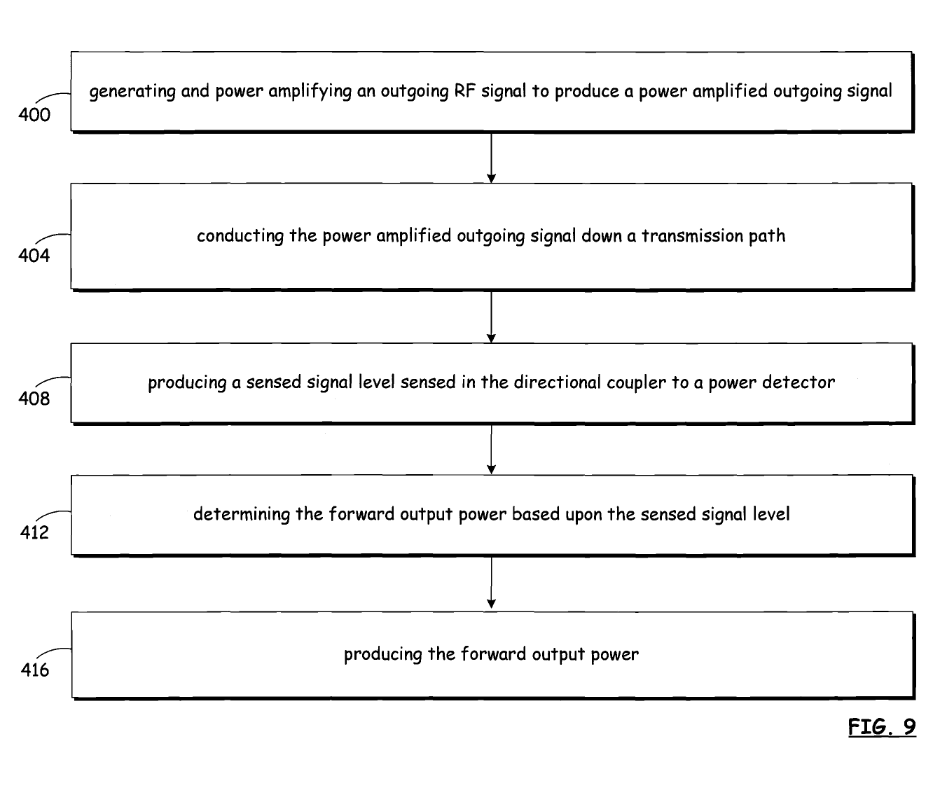

FIG. 9 is a flow chart that illustrates a method in an integrated circuit for detecting forward output power being produced by a power amplifier on a transmit path of the integrated circuit. The method comprises generating and power amplifying an outgoing RF signal to produce a power amplified outgoing signal (step 400) and subsequently conducting the power amplified outgoing signal down a transmission path (step 404). The transmission path is disposed substantially parallel to a directional coupler formed on a metallization layer of the integrated circuit in one embodiment of the invention. Further, the separation distance is a minimal value to improve sensing efficiency.

Thereafter, the method includes producing a sensed signal level sensed in the directional coupler to a power detector (step 408) and determining the forward output power based upon the sensed signal level (step 412). The sensed signal level may be based upon at least one of a current and voltage level (e.g., peak voltage level, average peak voltage level, etc.). Finally, the method includes producing the forward output power (step 416).

In one embodiment, producing the forward output power includes a power detection module producing a digital signal to logic which digital signal is a digital form of an output signal produced by the power detector which corresponds to the sensed signal level. For example, the power detection module (e.g., PDM 266, 320, 366) may produce a digital representation of the sensed forward output power level to a baseband processor of the integrated circuit radio transceiver. In an alternate embodiment, PDM 266, 320 or 366 produce a digital representation of the sensed signal to the baseband processor or other logic that subsequently determines the forward output power level based upon the sensed signal level. For example, defined logic may include utilizing a mapping table that map forward output power levels to sensed signal levels (e.g., digital signals that represent the sensed signal levels). In more general terms, however, the power detection modules produce the sensed forward output level for subsequent processing. The sensed forward output power level may also be in an analog (continuous) waveform that is subsequently converted to a digital form.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences. As one of ordinary skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled”.

While the invention is susceptible to various modifications and alternative forms, specific embodiments thereof have been shown by way of example in the drawings and detailed description. It should be understood, however, that the drawings and detailed description thereto are not intended to limit the invention to the particular form disclosed, but, on the contrary, the invention is to cover all modifications, equivalents and alternatives falling within the spirit and scope of the present invention as defined by the claims. As may be seen, the described embodiments may be modified in many different ways without departing from the scope or teachings of the invention.

1. An integrated circuit radio transceiver, comprising:
baseband processor for processing ingoing and outgoing digital communication signals;
transmitter front end for processing and transmitting outgoing RF signals based upon the outgoing digital communication signals, the transmitter front end including a power amplifier for increasing a forward output power level;
receiver front end for receiving ingoing RF signals and for processing the ingoing RF signals to produce the ingoing digital communication signals;
a power detection module formed on chip with the transmitter and receiver front ends, which power detection module is operably disposed to sense the forward output power level.

2. The integrated circuit radio transceiver of claim 1 wherein the power detection module comprises an on-chip directional coupler for sensing the forward output power level.

3. The integrated circuit radio transceiver of claim 2 wherein the directional coupler comprises a strip line formed on a metallization layer of the integrated circuit.

4. The integrated circuit radio transceiver of claim 1 wherein the directional coupler is a ¼ wavelength (directional coupler operable to detect forward output power levels at a frequency that is approximately a whole multiple of the RF transmission frequency.

5. The integrated circuit radio transceiver of claim 1 wherein the directional coupler further comprises two ⅛ wavelength directional couplers operable to detect forward output power levels at a frequency that is approximately a whole multiple of the RF transmission frequency.

6. The integrated circuit radio transceiver of claim 5 wherein each of the directional couplers is disposed substantially parallel to an outgoing transmission line that couples the power amplifier to the antenna.

7. The integrated circuit radio transceiver of claim 6 wherein each of the directional couplers is separated from the outgoing transmission line by a minimal separation distance.

8. The integrated circuit radio transceiver of claim 7 wherein the minimal separation distance is in the range of 2-5 microns.

9. The integrated circuit radio transceiver of claim 4 wherein the directional coupler is disposed substantially parallel to an outgoing transmission line that couples the power amplifier to the antenna.

10. The integrated circuit radio transceiver of claim 9 wherein the directional couplers is separated from the outgoing transmission line by a minimal separation distance.

11. The integrated circuit radio transceiver of claim 10 wherein the minimal separation distance is in the range of 2-5 microns.

12. A method in an integrated circuit for detecting forward output power being produced by a power amplifier on a transmit path of the integrated circuit, comprising:
generating and power amplifying an outgoing RF signal to produce a power amplified outgoing signal;
conducting the power amplified outgoing signal down a transmission path that is disposed substantially parallel to a directional coupler formed on a metallization layer of the integrated circuit;
producing a sensed signal level sensed in the directional coupler to a power detector; and
determining the forward output power based upon the sensed signal level.

13. The method of claim 12 further including sensing at least one of a voltage and a current in the transmission path.

14. The method of claim 12 further including producing a digital signal to logic which digital signal is a digital form of an output signal produced by the power detector which corresponds to the sensed signal level.

15. The method of claim 14 wherein the logic is operable to calculate a forward output power based upon the digital signal.

16. The method of claim 14 wherein the logic is operable to determine a forward output power based upon a mapping of forward output power levels to digital signal values.

17. An integrated circuit radio transceiver, comprising:
transmitter front end for processing and transmitting outgoing RF signals based upon the outgoing digital communication signals, the transmitter front end including a power amplifier for increasing a forward output power level;
receiver front end for receiving ingoing RF signals and for processing the ingoing RF signals to produce the ingoing digital communication signals;
an on-chip stripline directional coupler formed on a surface layer of the integrated circuit operably arranged to sense a forward output power in a transmission line; and
a power detection module formed on chip with the transmitter and receiver front ends, which power detection module is operably disposed to detect the forward output power level sensed by the stripline directional coupler.

18. The integrated circuit radio transceiver of claim 17 wherein the strip line directional coupler comprises a strip line formed on a metallization layer of the integrated circuit.

19. The integrated circuit radio transceiver of claim 17 wherein the strip line directional coupler is a ¼ wavelength directional coupler operable to detect forward output power levels at a frequency that is approximately a whole multiple of the RF transmission frequency.

20. The integrated circuit radio transceiver of claim 17 wherein the directional coupler further comprises two ⅛ wavelength directional couplers operable to detect forward output power levels at a frequency that is approximately a whole multiple of the RF transmission frequency.

21. The integrated circuit radio transceiver of claim 20 wherein each of the directional couplers is disposed substantially parallel to an outgoing transmission line that couples the power amplifier to the antenna.

22. The integrated circuit radio transceiver of claim 17 wherein a separation distance between the strip line directional coupler and an outgoing transmission line is in the range of 2-5 microns.

23. The integrated circuit radio transceiver of claim 17 wherein the directional coupler is disposed substantially parallel to an outgoing transmission line that couples the power amplifier to the antenna.
